(19) United States
(12) Patent Application Publication
(10) Pub. No.: US 2002/0143524 A1
(43) Pub. Date: Oct. 3, 2002

(54) Method and resulting system for integrating a query reformation module onto an information retrieval system

(75) Inventors: John H. O'Neil, Cambridge, MA (US); James D. Pustejovsky, Arlington, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LingoMotors, Inc., Cambridge, MA

(21) Appl. No.: 09/953,105

(22) Filed: Sep. 13, 2001

Related U.S. Application Data
(60) Provisional application No. 60/236,509, filed on Sep. 29, 2000.

(51) Int. Cl. G06F 17/27

(52) U.S. Cl. 704/9

(57) ABSTRACT

A method (and system) for converting a keyword based search engine coupled to a information source into a natural language enhanced search engine. The method includes determining expression based syntax of the keyword based search engine. The method then couples a natural language based search engine to the keyword based search engine based upon the expression based syntax by linking the natural language based search engine to the keyword based search engine.

### CROSS REFERENCES TO RELATED APPLICATIONS

This application is a nonprovisional of and claims priority to U.S. Prov. Appl. No. 60/236,509, filed Sept. 29, 2000 by John O'Neill et al, entitled “SEARCH ENGINE METHOD AND SYSTEM,” the entire disclosure of which is herein incorporated by reference.

This application is related to U.S. Appl. No. --/---,---, filed concurrently with the present application by John O'Neil et al., entitled “IMPROVED METHOD AND SYSTEM FOR QUERY REFORMULATION FOR SEARCHING OF INFORMATION” (Attorney Docket No. 19497-000210US), the entire disclosure of which is herein incorporated by reference for all purposes.

### BACKGROUND OF THE INVENTION

This invention generally relates to a knowledge based technique. More particularly, the present invention provides a way to integrate a query reformulation module to an information retrieval system. Merely by way of example, the present invention is implemented using a conventional information retrieval system coupled to a database, but it would be recognized that the invention has a much broader range of applicability. The invention can be applied to other sources of information from the Internet, a network of computers, and the like.

Networks, computers, and databases have proliferated the availability of information. Such information includes, among others, newspapers, magazines, advertisements, commercial publications, and commercial products in electronic form. By way of a world wide network of computers, which is known as the Internet, millions if not billions of pieces of information can be accessed through “browser” programs such as those made by Netscape Communications, Inc. of Mountain View, Calif. or Microsoft Corporation of Redmond, Wash. Information retrieval engines such as those made by Yahoo! and others allow a user to access such information using an indexing technique. The indexing technique often uses full-text indexing, in which content words in a document are used as keywords to be searched. Full text index searching has been one of way to retrieve information in conventional retrieval engines. Unfortunately, such full text searching is plagued with many problems. For example, a user of such searching often retrieves thousands of documents or hits or related documents and is therefore not precise. Such searching often requires refinement using a hit or miss strategy, which is often cumbersome and takes time and lacks efficiency. Accordingly, fall text searching has much room for improvement.

There have also been other attempts to search large quantities of information on systems using natural language techniques. Such natural language techniques often use simple logical forms, which are difficult to scale efficiently and lack precision using large quantities of information. For example, conventional natural language techniques often cause what is known as “combinatorial explosion” when the number of logical forms that are stored as templates grows. Accordingly, natural language techniques have not been able to be scaled for large complex information systems.

Additionally, such techniques have been separate from each other, where natural language search techniques have not been integrated into keyword search techniques. Even if such techniques have been integrated, integration is often difficult to achieve in an efficient and cost effective manner. Additionally, integration also requires some modification to the pre-existing technique that may influence reliability, operability, and dependability of the technique. Accordingly, there are many limitations with ways to integrate any of the conventional techniques.

From the above, it is seen that an improved way to acquire information using a knowledge based technique is highly desirable.

### SUMMARY OF THE INVENTION

According to the present invention, a technique including a method and system for a knowledge based technique is provided. More particularly, the invention provides an improved way of integrating a query reformulation module onto a pre-existing information retrieval system. In an exemplary embodiment, the invention provides an enhanced search technique that can be integrated into a conventional information retrieval method and system.

In a specific embodiment, the invention provides a method for converting a keyword based search engine coupled to a information source into a natural language enhanced search engine. The method includes determining expression based syntax of the keyword based search engine. The method then couples a natural language based search engine to the keyword based search engine based upon the expression based syntax by linking the natural language based search engine to the keyword based search engine.

In an alternative specific embodiment, the invention provides a method for converting an information retrieval search engine coupled to a information source into a natural language enhanced search engine. The method determines an expression based syntax of the information retrieval search engine. The information retrieval system comprises a graphical user interface coupled to a client device. The method then couples a query reformulation module to the information retrieval search engine. The query reformulation module is adapted to couple a natural language engine to the information retrieval search engine. In one embodiment, the natural language based search engine is trained with a corpus of the information source

Many benefits are achieved by way of the present invention over conventional techniques. For example, the invention allows a user to implement a natural language search engine overlying conventional search engines, without substantial modification. The invention can be applied using conventional computer software and/or hardware. In certain aspects, the invention can also provide for more directed searching to yield improved searching and the like. Depending upon the embodiment, one or more of these benefits may be achieved. These and other benefits will be described in more throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of an knowledge acquisition system according to an embodiment of the present invention;

FIG. 1A is a more detailed diagram of a query reformulation system according to an embodiment of the present invention;

FIG. 2 is a simplified flow diagram of a query reformulation method according to an embodiment of the present invention;

FIG. 3 is a more detailed diagram of a query reformulation method according to an embodiment of the present invention;

FIG. 4 is a more detailed diagram of a method for filtering selected non-interesting terms according to an embodiment of the present invention;

FIG. 5 is a more detailed diagram of a method for targeted field mapping of database fields according to an embodiment of the present invention;

FIG. 6 is a more detailed diagram of a method for adding expansion terms to a query term according to an embodiment of the present invention;

FIG. 7 is a more detailed diagram of a method for query normalization according to an embodiment of the present invention;

FIG. 8 is a simplified diagram of an illustration of integrating a query reformulation module onto a conventional information retrieval system according to an embodiment of the present invention;

FIG. 9 is a simplified system diagram of an integrated query reformation module and information retrieval system according to an embodiment of the present invention;

FIG. 9A is an example of an interface that may be used with certain aspects of the invention

FIG. 10 is a more detailed diagram of an integrated query reformation module and information retrieval system according to an embodiment of the present invention;

FIG. 11 is a simplified flow diagram of a method for integrating a query reformation module onto a conventional information retrieval system according to an embodiment of the present invention; and

FIGS. 12A-12E are schematic diagrams of an exemplary system described in a design and functional specification provided below.

### DESCRIPTION OF THE SPECIFIC EMBODIMENTS

According to the present invention, a technique including method and system for a knowledge based technique is provided. More particularly, the invention provides an improved way of integrating a query reformulation module onto a pre-existing information retrieval system. In an exemplary embodiment, the invention provides an enhanced search technique that can be integrated into a conventional information retrieval method and system.

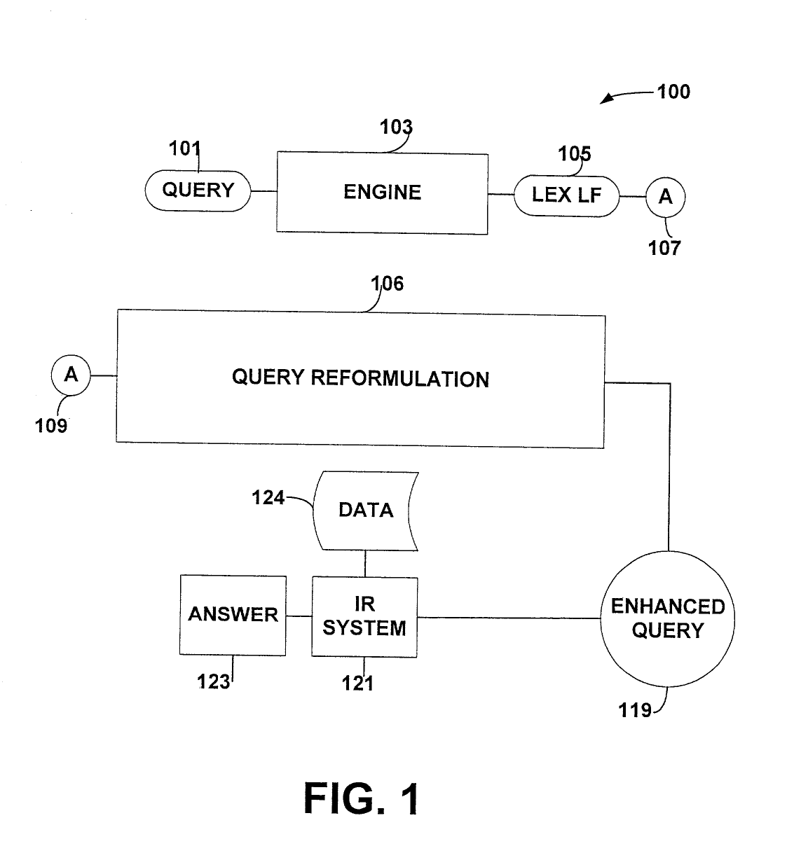

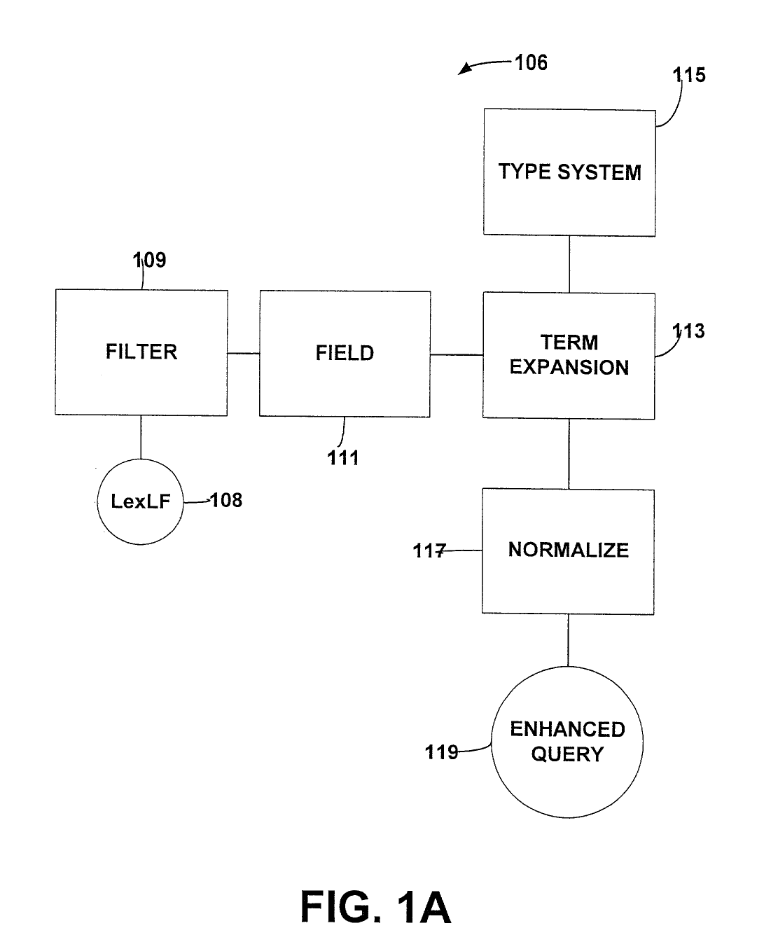

FIG. 1 is a simplified diagram of a system 100 according to an embodiment of the present invention. This diagram is merely an example, which should not unduly limit the scope of the claims herein. One of ordinary skill in the art would recognize many other variations, modifications, and alternatives. As shown, the system has input 101, where a user inputs a query. The query is generally in a natural language form. The query is indicated as an input query. The input query is provided into an engine 103 to convert the natural language form into a logical form such as a “LexLF” logical form 105 designed by a company called Lexeme, Inc. of Cambridge, Mass. The logical form is preferably one that has semantic information provided into the logical form. The logical form also has key terms of the query, among other information.

The logical form is derived from an engine developed by LingoMotors, Inc. As merely an example, the engine is described in copending, commonly owned U.S. Appl. No. 09/662,510 by Robert J. P. Ingria et al., filed Sept. 15, 2000, entitled “ANSWERING USER QUERIES USING A NATURAL LANGUAGE METHOD AND SYSTEM” (“the '510 application), and in copending, commonly owned U.S. appl. Ser. No. 09/663,044 by Federica Busa et al., filed Sept. 15, 2000, entitled “NATURAL LANGUAGE TYPE SYSTEM AND METHOD” (“the '044 application”), the entire disclosures of which are herein incorporated by reference in their entireties for all purposes. The engine can also be a variety of other suitable techniques. The output of the engine is indicated as the logical form LexLF. It should be noted that the term “LexLF” is merely intended to be a term for illustration purposes which should not in any way limit the scope of the claims herein.

The query in the logical form is fed into a query reformulation module 106. As shown, the logical form LexLF is fed into the query reformulation module through connector A 107, 109. The query reformulation module performs one or more operations on the query to make the query more efficient with other information retrieval systems. The query reformulation module feeds an enhanced query 119 into an information retrieval system 121, which is coupled to a data source 124. An answer 123 is outputted from the information retrieval system. Further details of the query reformulation module are provided below.

Referring to FIG. 1A, the query reformulation module includes a filter module 109, a term expansion module 113, a targeted field information module 111, and a query normalization module 117, and other elements, if desirable. The query reformulation module receives the logical form Lex LF 108. The query reformulation module outputs an enhanced query 119. Each of these modules are coupled to each other in the configuration shown, but can also be in other configurations. Preferably, the modules are coupled to each other in the configuration shown. In some embodiments of the invention, some of the modules can also be eliminated.

The filter module can be used to identify interesting or non-interesting terms in the query. In a specific embodiment, the filter module can be used to eliminate non-interesting terms, for example. Alternatively, the filter can identify interesting terms. Preferably, the interesting terms are identified using the format of the logical expression provided above. The logical expression identifies, for example, a format and topic of the request. Further details of the filter module are provided in accordance to the Figs. described below.

The targeted database field information module couples one or more fields of the database to the query to provide a more targeted query. In a specific embodiment, the targeted database information module provides one or more or all of the fields in the database to the query reformulation module. The information module provides the one or more fields of the database. The logical expression provides, for examples, terms that will be used for the query. In a specific embodiment, if a field term matches or is the same as one of the query terms, the matched query term is ignored in the term expansion module, which is described more fully below.

The term expansion module can provide expansion of terms using sets of synonyms and others. The term expansion is preferably based upon a typing system. An example of such a typing system is described in the '044 application, which has been incorporated by reference. Preferably, the term expansion module expands those terms that are not used as field terms. Here, the concept is to provide expansion for terms that are not expressly identified as a field, which is often implicitly an important term, as identified by the creator of the database, for example. Of course, there can be other ways to expand the terms that will provide other variations to the terms for completeness.

The query normalization module receives the query, which has been filtered and expanded. The module converts the query into a form that can be processed by an information retrieval system. In a specific embodiment, the query normalization module outputs an enhanced query 119 using a keyword logic technique. For example, the query normalization module will “and” selected terms and “or” expansion terms, which are connected with the “and” to the selected terms. Of course, the type of normalization will depend upon the application.

As shown, the query reformulation module is coupled to an information retrieval system 121 in FIG. 1. The information retrieval system can be any conventional known or other system. In a specific embodiment, the information retrieval system is a keyword search system using Boolean expressions or the like. The information retrieval system is often coupled to an information source such as a database 124. The database can be any suitable unit that has information that is arranged in some type of logical manner that can be stored and retrieved. An answer 123 based upon a combination of the information retrieval system and enhanced query is output. Further details of methods according to the present system are explained according to the figures. described below.

Some of the elements can be operated in serial or in parallel manner. Alternatively, the elements can be a combination of serial and parallel operations without departing from the scope of the claims herein. Further, although the above has been described in terms of specific hardware and software features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like. It is also understood that the examples and embodiments described herein are for illustrative purposes only and that various modifications or changes in light thereof will be suggested to persons skilled in the art and are to be included within the spirit and purview of this application and scope of the appended claims.

An embodiment of a method according to the present invention may be briefly outlined as follows:

1. Provide query in natural language format;

2. Perform preprocessing including steps of tokenizing, tagging, and stemming of the query in an engine;

3. Perform syntax analysis on the preprocessed query;

4. Form a logical form (e.g., LexLF) from the syntax analysis expression;

5. Perform filtering step to identify essential terms in query (or eliminate non-essential terms);

6. Perform a field information operation on essential terms of the query;

7. Perform a term expansion on each of the essential query terms;

8. Normalize processed query to a form suitable for an information retrieval system such as Boolean;

9. Output an enhanced Boolean expression based upon logical form;

10. Query database information based upon enhanced Boolean expression;

11. Identify selected information based upon enhanced query; and

12. Perform other steps as desirable.

The above sequence of steps is an example of a way to perform aspects of the present invention. They provide a general query in natural language form. They perform a syntax analysis on the query once the query has been pre-processed. An enhanced Boolean expression is based upon the logical form to provide a more focussed or efficient query to the information retrieval system. Further details of these steps are provided in reference to the Figs. described below.

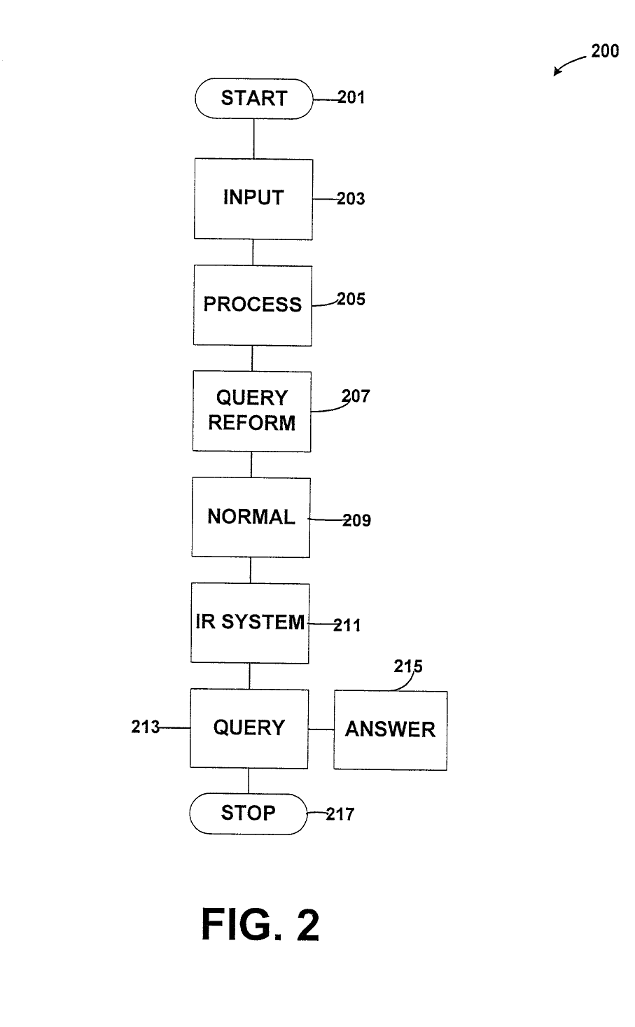

FIG. 2 is a simplified flow diagram 200 of an enhanced query reformulation method according to an embodiment of the present invention. This diagram is merely an example, which should not unduly limit the scope of the claims herein. One of ordinary skill in the art would recognize many other variations, modifications, and alternatives. As shown, the method begins at start, step 201. The method inputs a query 203. The query is generally in a natural language form. The query is indicated as an input query. The input query is provided into an engine for processing 205 to convert the natural language form into a logical form such as the LexLF logical form designed by a company called LingoMotors, Inc. of Cambridge, Mass. The logical form is preferably one that has semantic information provided into the logical form. The logical form also has key terms of the query, among other information.

The logical form is derived from an engine developed by LingoMotors, Inc. As merely an example, the engine is described in the '510 and '044 applications, which have been incorporated by reference. The engine can also be a variety of other suitable techniques. The output of the engine is indicated as the logical form LexLF. It should be noted that the term “LexLF” is merely intended to be a term for illustration purposes which should not in any way limit the scope of the claims herein.

The query in the logical form undergoes a process of reformulation, block 207. In a specific embodiment, the reformulation process occurs in a reformulation module, such as the one noted but can be others. The query reformulation module performs one or more operations on the query to make the query more efficient with other information retrieval systems. In a specific embodiment, the query reformulation module includes a filter module, a term expansion module, a targeted field information module, and other elements, if desirable. In some embodiments of the invention, some of the modules can also be eliminated, combined, or others added. Further details of the methods performed in each of these modules are provided below.

Next, the method processes the reformulated query and normalizes (step 209) it into a format suitable for an information retrieval system. In a specific embodiment, the query normalization process outputs an enhanced query using a keyword logic technique. For example, the query normalization process will “and” selected terms and “or” expansion terms, which are connected with the “and” to the selected terms. Of course, the type of normalization will depend upon the application.

The enhanced query is processed through an information retrieval process, block 211. The information retrieval process can be any conventional known or other system. In a specific embodiment, the information retrieval process is a keyword search system using Boolean expressions or the like. The information retrieval process uses the enhanced query (block 213) to query a database. The database can be any suitable unit that has information that is arranged in some type of logical manner that can be stored and retrieved. An answer 215 based upon a combination of the information retrieval system and enhanced query is output. The method stops, block 217, once the answer is provided to the user of the method.

The above sequence of steps is merely illustrative. The steps can be performed using computer software or hardware or a combination of hardware and software. Any of the above steps can also be separated or be combined, depending upon the embodiment. In some cases, the steps can also be changed in order without limiting the scope of the invention claimed herein. One of ordinary skill in the art would recognize many other variations, modifications, and alternatives.

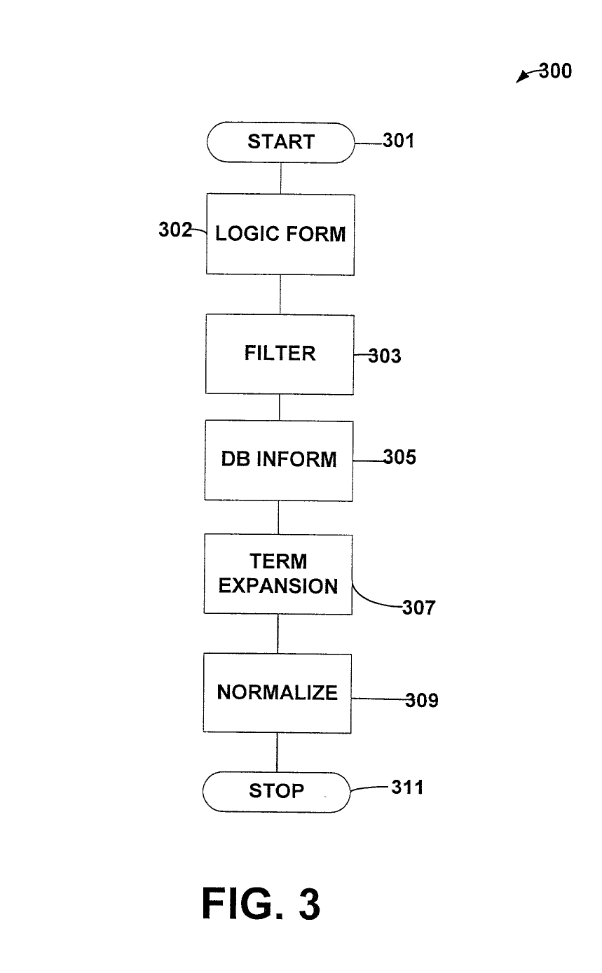

FIG. 3 is a more detailed diagram 300 of a query reformulation method according to an embodiment of the present invention. This diagram is merely an example, which should not unduly limit the scope of the claims herein. One of ordinary skill in the art would recognize many other variations, modifications, and alternatives. As shown, the method begins at start, block 301. The method inputs a query, such as the one noted, as well as others. The query is generally in a natural language form. The query is indicated as an input query. Using, for example, a simple illustration of searching for specific types of books in an electronic commerce web site, such as Amazon.com, Inc. or Barnes and Noble.com, Inc., among others. A typical query may be as follows:

Query=Do you have paperback books on gardening?

The input query is provided into an engine to convert the natural language form into a logical form such as a LexLF logical form designed by a company called LingoMotors, Inc. of Cambridge, Mass. The logical form is preferably one that has semantic information provided into the logical form. The logical form also has key terms of the query, among other information.

The logical form is derived from an engine developed by LingoMotors, Inc. As merely an example, the engine is described in the '510 and '044 applications, which have been incorporated by reference. The engine can also be a variety of other suitable techniques. The output of the engine is indicated as the logical form LexLF. It should be noted that the term “LexLF” is merely intended to be a term for illustration purposes which should not in any way limit the scope of the claims herein. An example of a logical form for the above query is as follows:

LexLF: [utterance=YIN Question,

type=request for information, lexical item=have

domain=book retailer, lexical item=book

format=paperback

topic of book=gardening]

The query in the logical form undergoes a process of reformulation. In a specific embodiment, the reformulation process occurs in a reformulation module, such as the one noted but can be others. The query reformulation module performs one or more operations on the query to make the query more efficient with other information retrieval systems. In a specific embodiment, the query reformulation module includes a filter module, a term expansion module, a targeted field information module, and other elements, if desirable. In some embodiments of the invention, some of the modules can also be eliminated, combined, or others added. Further details of the methods performed in each of these modules are provided below.

In a specific embodiment, the method performs a filter process, block 303, on the logical form. The filter process can be used to identify interesting or non-interesting terms in the query. In a specific embodiment, the filter process can be used to eliminate non-interesting terms. Alternatively, the filter process can identify interesting terms. Preferably, the interesting terms are identified using the format of the logical expression provided above. The logical expression identifies, for example, a format and topic of the request. An example of a filtered query would yield the following expressions from the logical form.

Format=paperback

Topic=gardening

Next, the method performs a field information process, block 305. In a specific embodiment, the targeted database information process provides one or more or all of the fields in the database to the query reformulation process. The information process provides the one or more fields of the database. The logical expression provides, for examples, terms that will be used for the query. In a specific embodiment, if a field term matches or is the same as one of the query terms, the matched query term is ignored in the term expansion process, which is described more fully below. As merely an example, the database fields that were identified in the query have been highlighted in bold below.

[ utterance=YIN Question type=request for information

lexical item =have

domain=book retailer

lexical item=book

format=paperback

topic of book=gardening]

As shown, the fields include, for example, “domain=book retailer, lexical item=book, format=paperback.” Next, the method performs a term expansion process (block 307) to expand selected terms that have not been identified as field terms. The term expansion process can provide expansion of terms using sets of synonyms and others. The term expansion is preferably based upon a typing method. An example of such a typing method is described in the '044 application, which has been incorporated by reference. Preferably, the term expansion method expands or finds alternative terms for those terms that are not used as field terms. Here, the concept is to provide expansion for terms that are not expressly identified as a field, which is often implicitly an important term, as identified by the creator of the database, for example. Of course, there can be other ways to expand the terms that will provide other variations to the terms for completeness. Using the above example, the term “gardening” has been expanded to include the following other expressions.

Topic=gardening (not a database field)

Expanded gardening to also include “horticulture, landscaping, floriculture.”

Next, the method processes the reformulated query and normalizes (block 309) it into a format suitable for an information retrieval system. In a specific embodiment, the query normalization process outputs an enhanced query using a keyword logic technique. For example, the query normalization process will “and” selected terms and “or” expansion terms, which are connected with the “and” to the selected terms. Of course, the type of normalization will depend upon the application. Using again, the above example, the original query has been converted into an enhanced Boolean expression, which will be used in a conventional information retrieval method.

Book retailer and paperback and (gardening or horticulture or landscaping or floriculture)

The enhanced query is processed through an information retrieval process. The information retrieval process can be any conventional known or other system. In a specific embodiment, the information retrieval process is a keyword search system using Boolean expressions or the like. The information retrieval process uses the enhanced query to query a database. The database can be any suitable unit that has information that is arranged in some type of logical manner that can be stored and retrieved. An answer based upon a combination of the information retrieval system and enhanced query is output. The method stops, block 311, once the answer is provided to the user of the method.

The above sequence of steps is merely illustrative. The steps can be performed using computer software or hardware or a combination of hardware and software. Any of the above steps can also be separated or be combined, depending upon the embodiment. In some cases, the steps can also be changed in order without limiting the scope of the invention claimed herein. One of ordinary skill in the art would recognize many other variations, modifications, and alternatives.

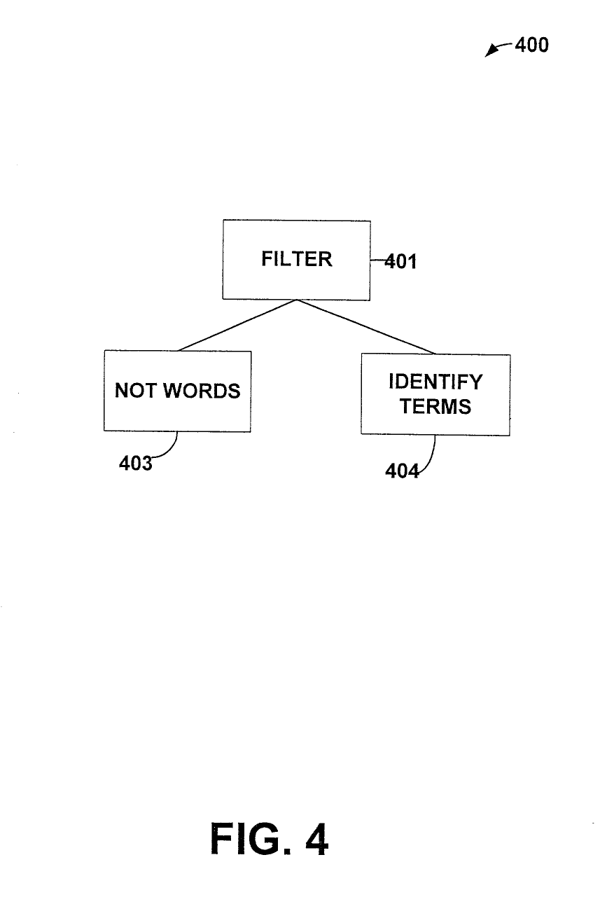

FIG. 4 is a more detailed diagram 400 of a method for filtering selected non-interesting terms according to an embodiment of the present invention. This diagram is merely an example, which should not unduly limit the scope of the claims herein. One of ordinary skill in the art would recognize many other variations, modifications, and alternatives. The present method can include a filter process, 400. In a specific embodiment, the method performs a filter process, block 401, on a logical form such as the one described herein or others. The filter process can be used to identify interesting or non-interesting terms in the query. In a specific embodiment, the filter process can be used to eliminate non-interesting terms 403. Alternatively, the filter process can identify interesting terms 404. Preferably, the interesting terms are identified using the format of the logical expression provided above. The filter process can identify or eliminate non-interesting terms from a listing 403 of non-interesting terms, which are provided by a user. For example, the listing can be a “not” list for terms which are eliminated. As merely an example, the not list can include terms such as “looking for,” “where,” “find,” and other conventional query stop words, but also contextually identified terms as a result of linguistic processing of the query, all of which are shown for illustrative purposes only. Alternatively or in combination, the filter process can identify interesting or non-interesting terms based upon the terms identified by the logical expression, such as the example above. Depending upon the embodiment, there can be other ways to filter the logical form.

The above sequence of steps is merely illustrative. The steps can be performed using computer software or hardware or a combination of hardware and software. Any of the above steps can also be separated or be combined, depending upon the embodiment. In some cases, the steps can also be changed in order without limiting the scope of the invention claimed herein. One of ordinary skill in the art would recognize many other variations, modifications, and alternatives.

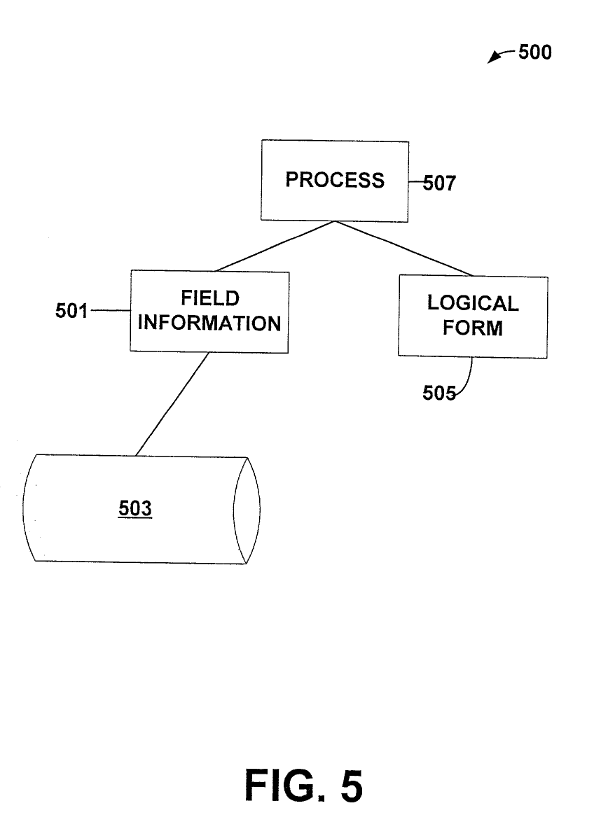

FIG. 5 is a more detailed diagram 500 of a method for targeted field-information according to an embodiment of the present invention. This diagram is merely an example, which should not unduly limit the scope of the claims herein. One of ordinary skill in the art would recognize many other variations, modifications, and alternatives. In a specific embodiment, the method performs a field information process 500. In a specific embodiment, the method derives field information 501 from a database 503. The field information includes one or more or all of the fields in the database. The fields of the database are processed (block 507) with the terms provided by a logical form 505, which has been derived from an engine and query. Here, the terms in the logical form may be a starting point for terms to be used for the enhanced query. In a specific embodiment, if a field term matches or is the same as one of the query terms, the matched query term is ignored in the term expansion process, which is described more fully below.

Again, the above sequence of steps is merely illustrative. The steps can be performed using computer software or hardware or a combination of hardware and software. Any of the above steps can also be separated or be combined, depending upon the embodiment. In some cases, the steps can also be changed in order without limiting the scope of the invention claimed herein. One of ordinary skill in the art would recognize many other variations, modifications, and alternatives.

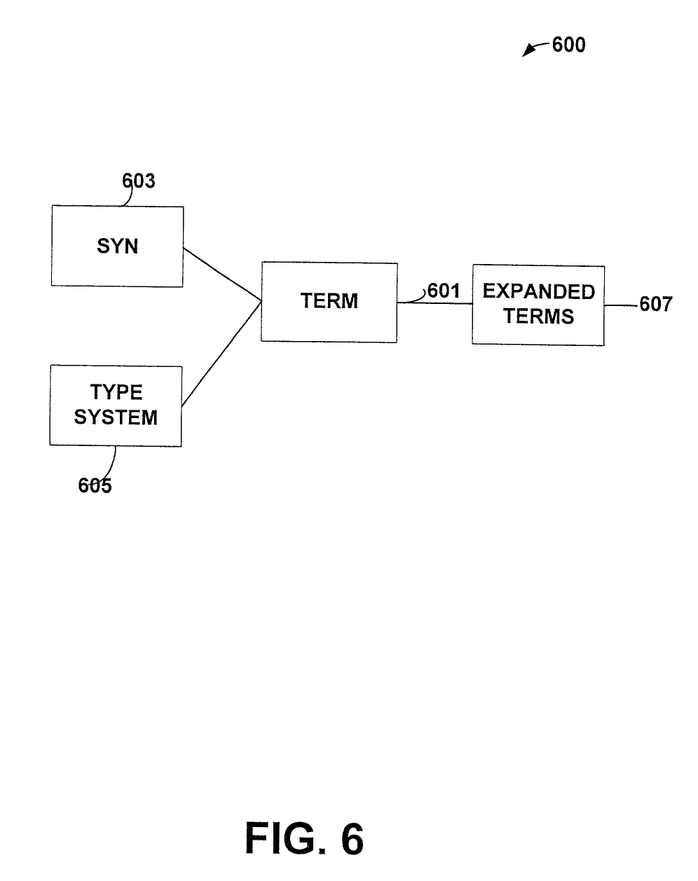

FIG. 6 is a more detailed diagram 600 of a method for adding expansions to a query term according to an embodiment of the present invention. This diagram is merely an example, which should not unduly limit the scope of the claims herein. One of ordinary skill in the art would recognize many other variations, modifications, and alternatives. The method performs a term expansion process 600 to expand selected terms 601 that have not been identified as field terms. The term expansion process can provide expansion of terms using sets of synonyms (block 603) and others, which are derived from a library. The term expansion can also be based upon a typing method, block 605, which can be combined with synonyms. An example of such a typing method is described in the '044 application, which has been incorporated by reference. Preferably, the term expansion method expands or finds alternative terms 607 for those terms that are not used as field terms. Here, the concept is to provide expansion for terms that are not expressly identified as a field, which is often implicitly an important term, as identified by the creator of the database, for example. Of course, there can be other ways to expand the terms that will provide other variations to the terms for completeness.

The above sequence of steps is merely illustrative. The steps can be performed using computer software or hardware or a combination of hardware and software. Any of the above steps can also be separated or be combined, depending upon the embodiment. In some cases, the steps can also be changed in order without limiting the scope of the invention claimed herein. One of ordinary skill in the art would recognize many other variations, modifications, and alternatives.

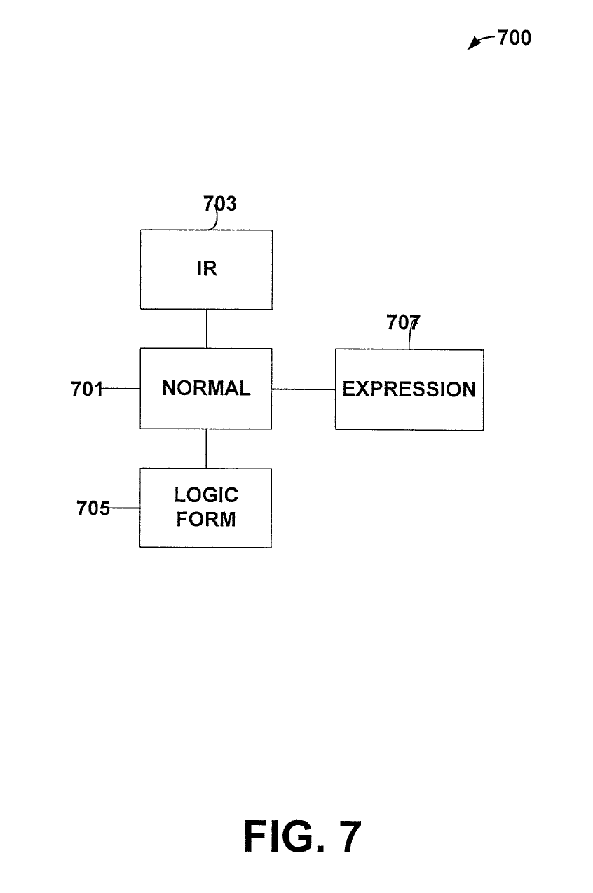

FIG. 7 is a more detailed diagram 700 of a method for query normalization according to an embodiment of the present invention. This diagram is merely an example, which should not unduly limit the scope of the claims herein. One of ordinary skill in the art would recognize many other variations, modifications, and alternatives. In a specific embodiment, the method processes the reformulated query in a logical form 705 and normalizes (block 701) it into a format suitable for an information retrieval method, block 703. In a specific embodiment, the query normalization process outputs an enhanced query (block 707) using a keyword logic technique. For example, the query normalization process will “and” selected terms and “or” expansion terms, which are connected with the “and” to the selected terms. Of course, the type of normalization will depend upon the application.

The above sequence of steps is merely illustrative. The steps can be performed using computer software or hardware or a combination of hardware and software. Any of the above steps can also be separated or be combined, depending upon the embodiment. In some cases, the steps can also be changed in order without limiting the scope of the invention claimed herein. One of ordinary skill in the art would recognize many other variations, modifications, and alternatives.

A method according to an embodiment of the present invention for integrating a query reformation module onto an information retrieval system is provided as follows.

(1) Provide information retrieval (“IR”) system which is coupled to an information source comprising corpus from a customer;

(2) Determine syntax expression used by the IR system;

(3) Convert user interface box to make it larger to input natural language input expression;

(4) Identify database fields from information source that are desirable (e.g., important) for the customer;

(5) Integrate query reformulation module onto information retrieval system;

(6) Train query reformulation module with the corpus of the information source from customer;

(7) Train the filter (e.g., non-interesting terms) in the query reformulation module on query set from the customer; and

(8) Perform other steps, as desirable.

The above sequence of steps is used to integrate a query reformulation module onto a conventional information retrieval system. These steps can provide, for example, an enhanced query, which is more accurate and retrieves more selected information. Additionally, the steps are easy to implement and can be used with any conventional technique. Further details of these steps are provided throughout the present specification and more particularly below according to the following figures.

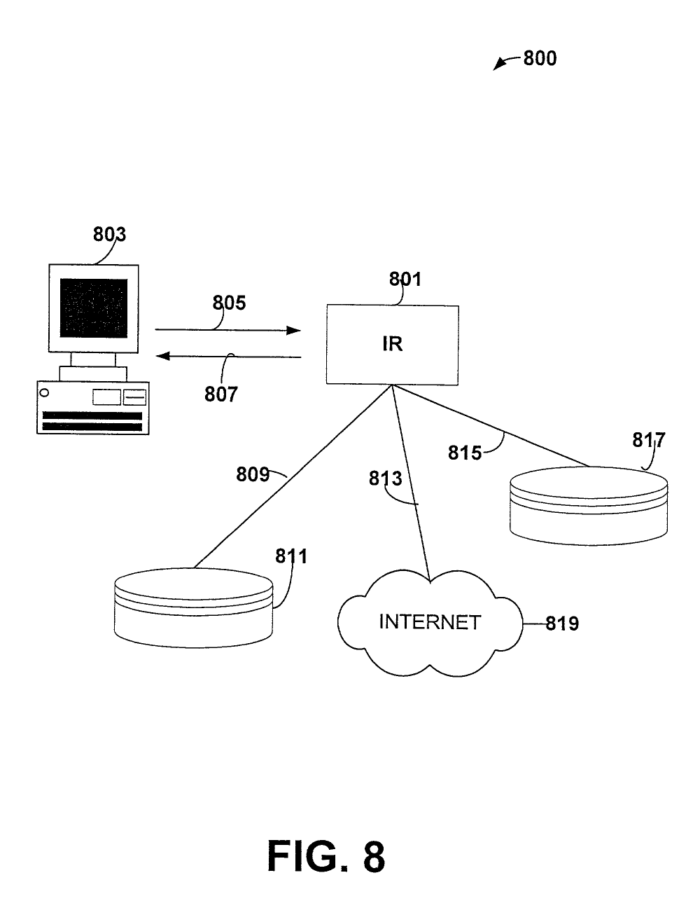

FIG. 8 is a simplified diagram 800 of an illustration of integrating a query reformulation module onto a conventional information retrieval system according to an embodiment of the present invention. This diagram is merely an example, which should not unduly limit the scope of the claims herein. One of ordinary skill in the art would recognize many other variations, modifications, and alternatives. As shown, the diagram 800 has an information retrieval system 801, which is coupled to a variety of information sources. Here, the information sources can include a relational database 811, the Internet 819, and text database 817. The information retrieval system 801 is coupled to relational database 811 via line 809. The information retrieval system 801 is coupled to the Internet via line 813. The information retrieval system 801 is coupled to text database via line 815. These lines are provided for illustrative purposes only. The lines can be in the form of hardware such as a hardwire or wireless or a combination of hardwire and wireless.

A user sends a query 805 from client 803 to the information retrieval system. An answer from the information retrieval system 801 is provided to client 803 via line 807. The client 803 can be a personal computer, a workstation, a mobile communication device, a personal digital assistant, and other client devices. Before integrating a query reformulation module onto the information retrieval system, it is desirable to obtain the following parameters. For example, the method should determine the syntax expression used by the information retrieval system. Here, the output of the query reformulation module would need to provide an enhanced expression in the syntax used by the information retrieval system. Additionally, other parameters that may be useful would be the database fields and knowledge of the corpus of the information source. Knowledge of specific database fields allows for directed identification and extraction of that information from the query. Similarly, training the engine and lexicon on the domain corpus enables more exact and targeted identification of keywords and their reformulations. Further details of integrating such query reformulation module onto the information retrieval system are provided throughout the present specification and more particularly below.

Although the above has been described in terms of specific hardware and software features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like.

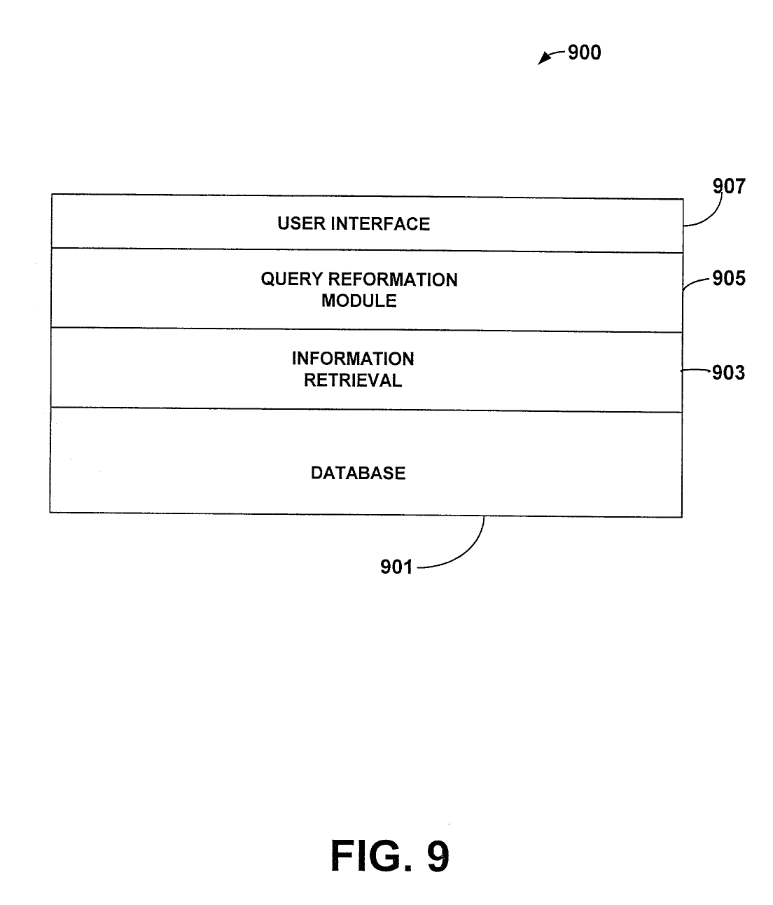

FIG. 9 is a simplified system diagram of an integrated query reformation module and information retrieval system 900 according to an embodiment of the present invention. This diagram is merely an example, which should not unduly limit the scope of the claims herein. One of ordinary skill in the art would recognize many other variations, modifications, and alternatives. As shown, the diagram includes an information source 901, which is a database. An information retrieval system 903 is coupled to the database. The information retrieval system 903 can be any conventional known or other system. In a specific embodiment, the information retrieval system is a keyword search system using Boolean expressions or the like. A query reformulation module 905 couples to the information retrieval system. The query reformulation module takes a natural language query, reformulates it, and sends it to the information retrieval system. The natural language query is provided by a user interface 907. As merely an example, the user interface is larger in size to take on a natural language query. An example of such a user interface is provided in FIG. 9A, for example.

Although the above has been described in terms of specific hardware and software features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like.

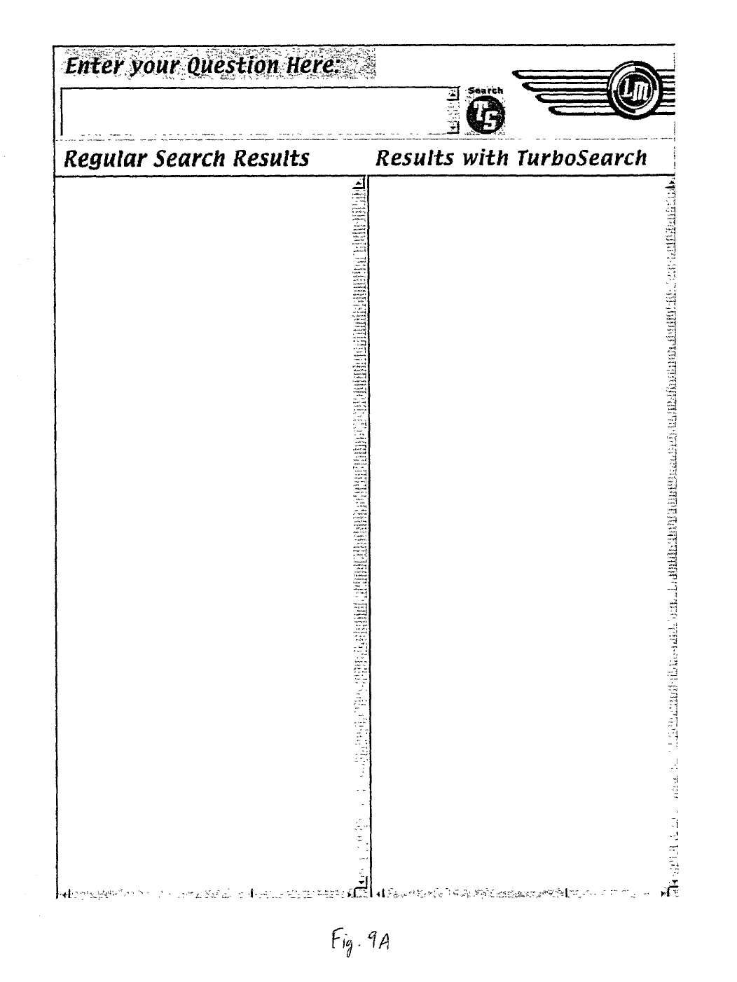

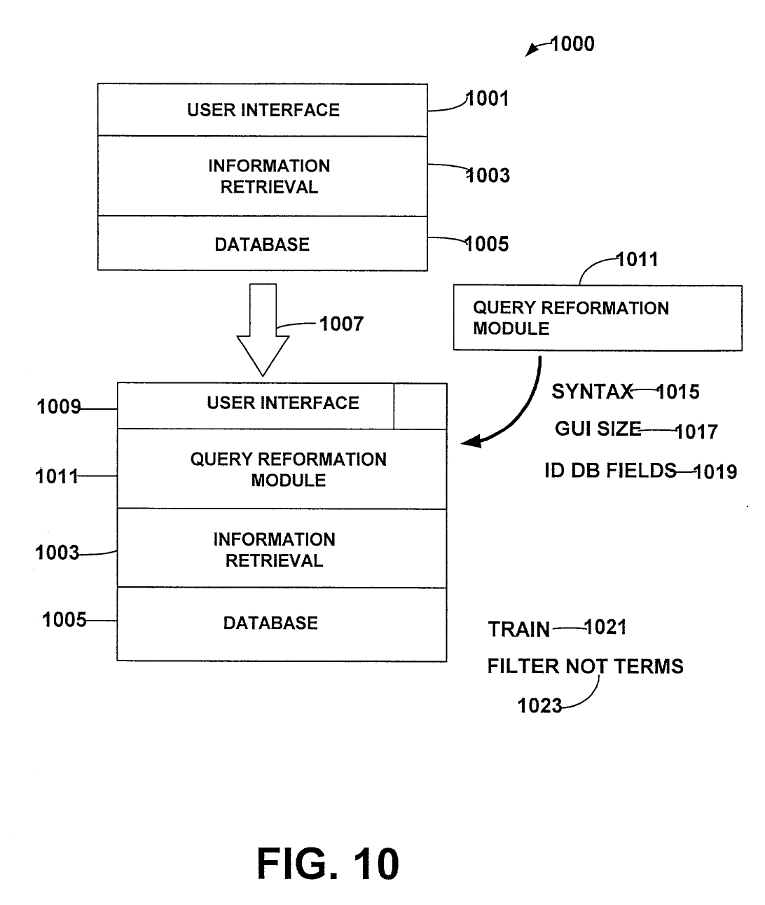

FIG. 10 is a simplified flow diagram 1000 of a method for integrating a query reformation module to a conventional information retrieval system according to an embodiment of the present invention. This diagram is merely an example, which should not unduly limit the scope of the claims herein. One of ordinary skill in the art would recognize many other variations, modifications, and alternatives. As shown, the method includes providing an information retrieval (“IR”) system 1003 which is coupled to an information source 1005 from a customer. The IR system is coupled to user interface 1001.

Before integrating 1007 a query reformulation module onto the information retrieval system, it is desirable to have certain parameters identified. For example, the method determines 1015 the syntax expression used by the IR system. The method also determines the size 1017 of the text box for the user interface and converts the user interface box to make it larger to input a natural language input expression. The method also identifies database fields 1019 from information source that are desirable (e.g., important) for the customer.

Next, the method integrates 1007 a query reformulation module 1011 onto information retrieval system. The integrated system includes an improved user interface 1009 coupled to a query reformulation module 1011, which is coupled to the information retrieval system 1003. The information retrieval system is coupled to database 1005.

The method then performs selected training steps to enhance operation of the integrated system. Here, the method trains 1021 the query reformulation module with the corpus of the information source from customer. Next, the method trains 1023 the filter (e.g., non-interesting terms) in the query reformulation module on query set from the customer. The Example provided below illustrates various features of the method.

Although the above has been described in terms of specific hardware and software features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like.

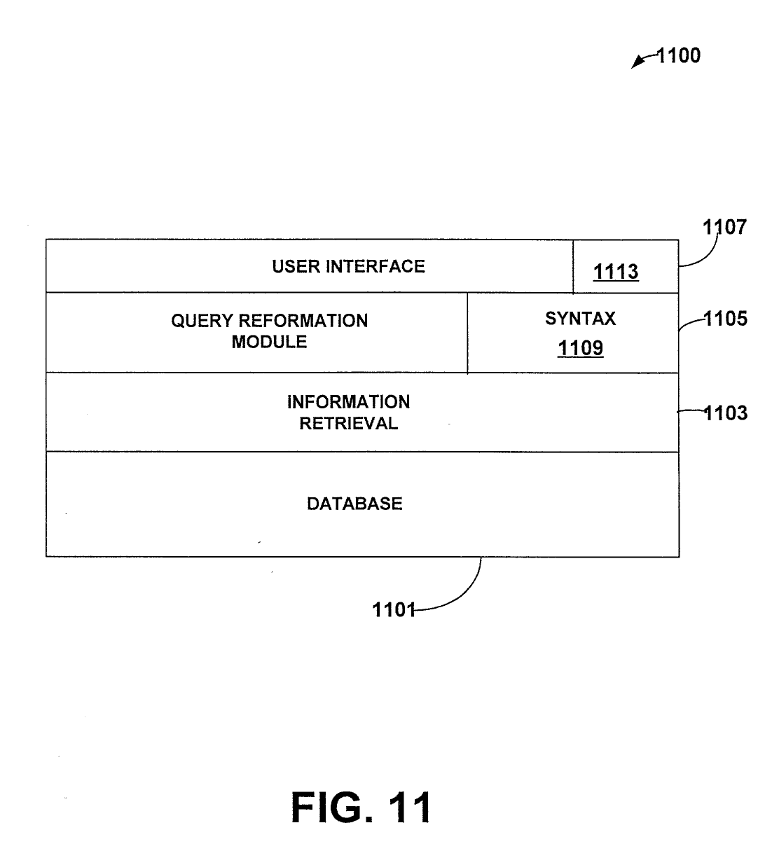

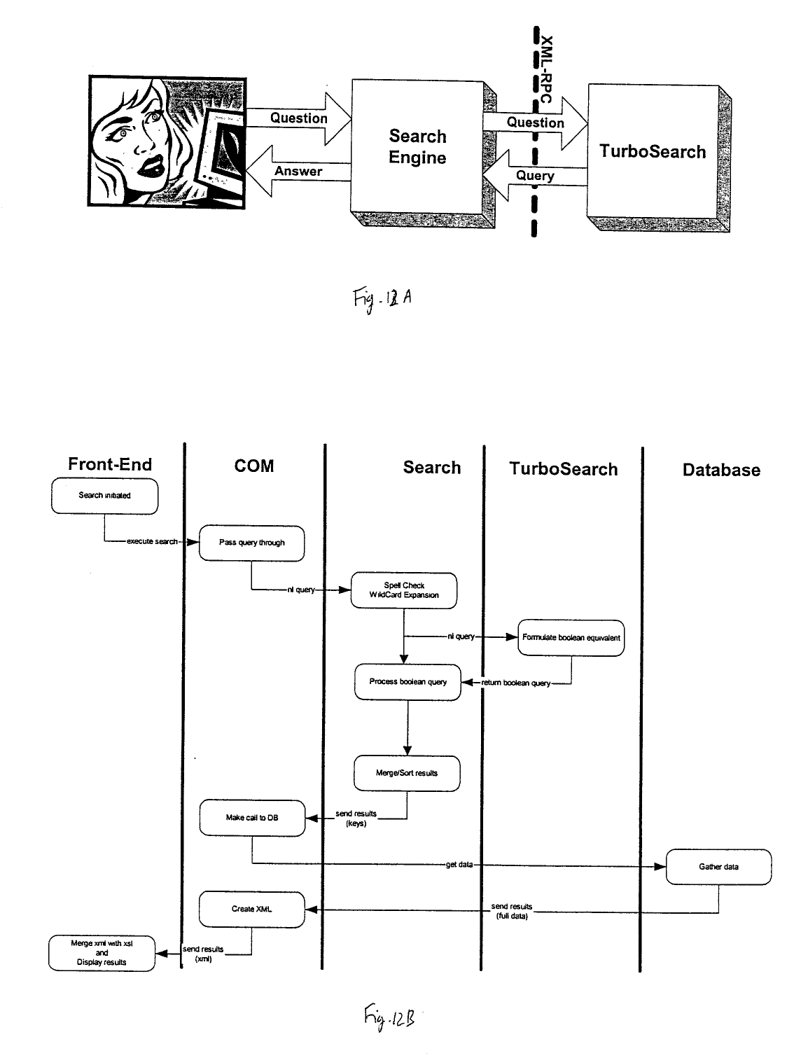

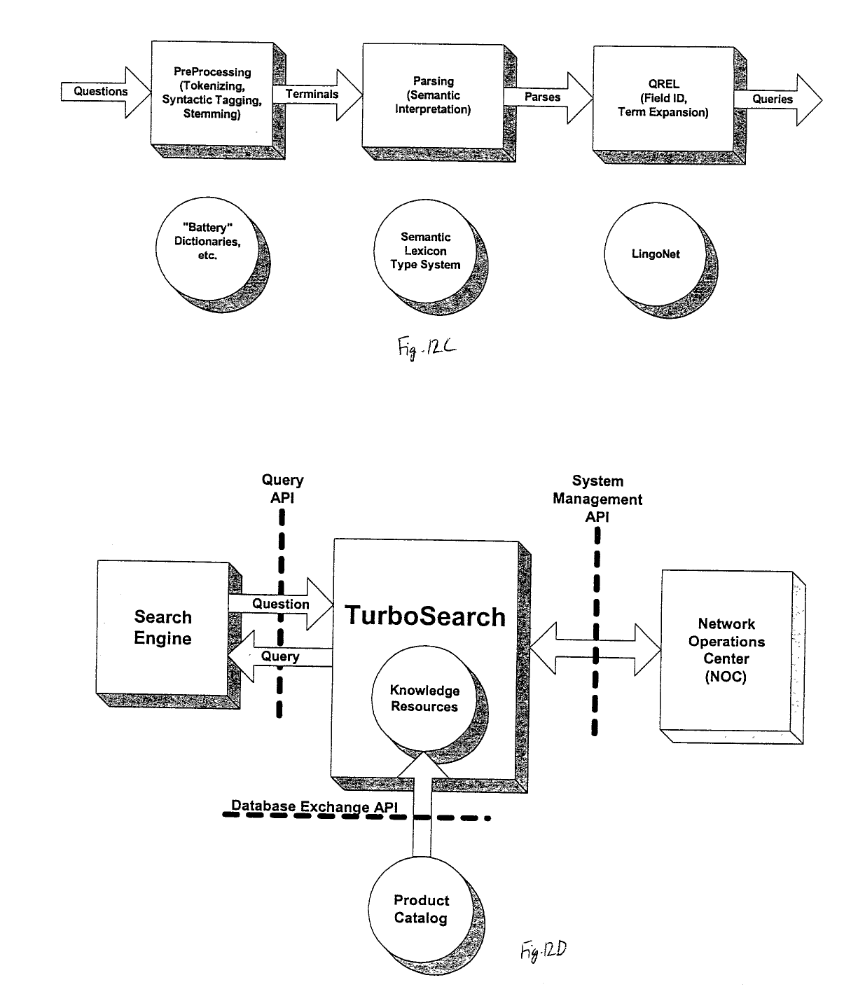

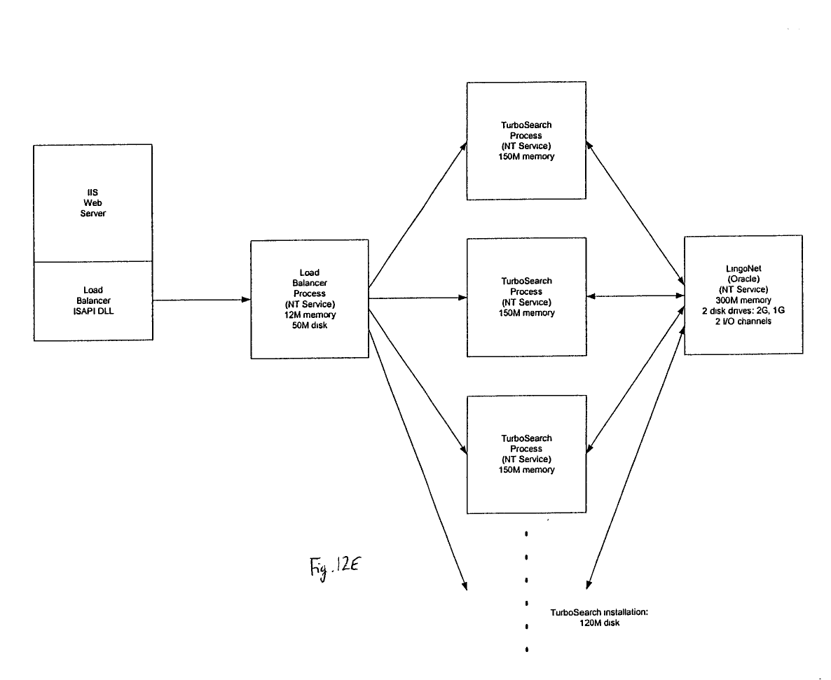

FIG. 11 is a more detailed diagram of an integrated a query reformation module and a conventional information retrieval system 1100 according to an embodiment of the present invention. This diagram is merely an example, which should not unduly limit the scope of the claims herein. One of ordinary skill in the art would recognize many other variations, alternatives, and modifications. As shown, the diagram includes an information source 1101, which is a database. An information retrieval system 1103 is coupled to the database. The information retrieval system can be any conventional known or other system. In a specific embodiment, the information retrieval system is a keyword search system using Boolean expressions or the like. A query reformulation module 1105 couples to the information retrieval system. The query reformulation module takes a natural language query, reformulates it, and sends it to the information retrieval system. The query reformulation module includes a normalization module 1109, which provides the enhanced expression in the proper syntax for the information retrieval system. The natural language query is provided by a user interface 1107. As merely an example, the user interface is larger 1113 in size to take on a natural language query. The Example provided below illustrates various features of the method

Although the above has been described in terms of specific hardware and software features, it would be recognized that there can be many alternatives, variations, and modifications. For example, any of the above elements can be separated or combined. Alternatively, some of the elements can be implemented in software or a combination of hardware and software. Alternatively, the above elements can be further integrated in hardware or software or hardware and software or the like.

### EXAMPLE

To prove the principle and operation of the present invention, we have prepared computer code and implemented the present invention using a database including information for books. The invention as implemented is described in the following design and functional specification. This design and functional specification is merely an example and should not limit the scope of the claims herein. One of ordinary skill in the art would recognize many variations, alternatives, and modifications.

### 1. Overview

LingoMotors's TurboSearch enhances conventional search systems by adding language understanding capability. Users can enter a question in ordinary language, and this is translated into a keyword query, in a Boolean format. There are three primary ways in which TurboSearch improves upon keyword search or literal Boolean search:

A. Ordinary Language Input—users can comfortably type in English. TurboSearch determines which words are part of the key concepts in the question, and which are contextual. Contextual words and phrases, which are useful for understanding queries include: stop phrases (e.g., ‘1 am interested in . . . ’) and function vocabulary (e.g., by, for, etc.). These are used by the engine to build more accurate semantic representations, but they are hidden to the user and are not included in the Boolean format since, as literal words, they add noise and substantially reduce the quality of search.

B. Field Identification—TurboSearch finds phrases and constructions that map to specific database fields accessible to the target search engine. This allows highly relevant search without requiring the user to work with complex templates. Field recognition uses both syntactic forms and semantic understanding. The specific fields to be identified and the parameters involved are dependent on the application and the search engine's database; these are developed and tested as part of the customization of TurboSearch for a given application.

C. Term expansion—TurboSearch expands the key concepts in a question into synonym sets (called “synsets”) which are input into the existing search engine. Stop phrases and other contextual words are not expanded but used to enhance interpretation and identification of key concepts. According to the type of key concept, there are distinct ways of creating an expansion. Geographical areas are expanded into locales; other expansions are provided as required for a particular application.

TurboSearch is a part of an overall system including a search engine, database, and web server. Multiple copies of all components are to be deployed across multiple locations, monitored from multiple Network Operations Centers (NOCs).

Features of the current version include:

A. Field Identification

a. Enhancements to existing fields (Contributor, Format)

b. New fields (Price, Pub Date)

B. Stop Phrases

a. Substantially expanded set of stop phrases

b. Enhanced testing for consistency & feature interaction

C. Term Expansion

a. Tuning “knobs” for synset & locale expansion

b. Major LingoNet enhancements, tuning and data cleanup

D. Platform & Performance tuning

a. Support for Microsoft DataCenter

b. Performance enhancements to reduce hardware requirements

E. System Management

a. Additional Logging and Alarms

b. Implementation of initial Reports & Stats

c. Network Management integration

F. Linguistic feature enhancements

a. “ing” form improvements

b. improved resolution of author name/common noun ambiguity

G. Vocabulary buildup

a. Domain-specific knowledge acquisition

b. Substantial tuning and data cleanup

H. Platform & Performance tuning

a. Support for Windows 2000

b. Performance optimization to reduce average and maximum latency

c. Database enhancements

d. Load balancing tuning, out-of-service service capability, and performance improvement

I. New and enhanced Tools

a. Log analysis

b. Knowledge acquisition

c. Version control

2. System Context

TurboSearch is an “add-on” to a conventional search engine. It converts “questions” (either in natural language or in keyword language) into “queries” in annotated Boolean format. The search engine and TurboSearch are deployed as separate components (typically on separate servers), with an XML-RPC interface between them. A schematic figure illustrating the relationship between the Search Engine and TurboSearch Engine is provided in FIG. 8A.

One deployment includes four sets of servers: Web Servers (hosting both the front-end web pages and a COM object that encapsulates communication), Search Servers, TurboSearch Servers, and Database Servers. The flow of control is shown schematically in FIG. 8B. The Search and TurboSearch components work together to generate a set of answers in the form of product IDs and category IDs; detailed information (book descriptions, cover pictures, etc.) is then fetched from the database.

The Search, TurboSearch, and Database components are stateless. Sets of servers are deployed across multiple data centers with load balancing hardware between them. Two successive queries from a given end user would typically go to different servers, with session context kept only on the front end.

### 3. High-Level Architecture

The high-level architecture for TurboSearch is shown schematically in FIG. 8C. Questions are distilled into “terminal” form through sophisticated linguistic processing that reduces words and phrases to their root forms and identifies their part of speech in context. Powerful proprietary techniques are used to interpret the meaning of the question, and distill it into one or more parses, each of which contains the key concepts and connections between them. These parses are then used to identify fields (specific kinds of concepts in specific connections), stop phrases, and terms to be expanded; the resulting query is formatted and returned to the search engine.

LingoMotors' linguistic understanding technology is “lexically driven”. Numerous interrelated dictionaries, thesauri, and ontologies are used in the course of processing each question. These are collectively termed “knowledge resources”; they are built using a sophisticated toolset and knowledge acquisition process.

4. Interface Description

TurboSearch has three points of interface, as shown schematically in FIG. 8D.

A. Query API—this uses XML-RPC to carry a question from a Search Engine to TurboSearch and return the reformulated query.

B. System Management API—this provides system configuration, software management, and reporting capabilities. This API is typically used by LingoMotors to provide system management on a hosted basis, but may be used by system management staff for self-hosting customers. (Note that this does not replace the application service functions provided by LingoMotors).

C. Database exchange API—application data is used to enhance and test the Knowledge Resources within TurboSearch. The database exchange may be in nearly any format. This is not a real-time interface; periodic updates are used to keep the system “fresh”.

A. Query API—Contents

The question input to TurboSearch is a string in ordinary language, as typed by the user. For example, the following are typical questions:

“I'm interested in essays on sailing”

“looking for something to help with a headache”

“Show me nonfiction books by Isaac Asimov”

“laptops with large screens under 7 pounds”

The resulting reformulated query is in Boolean syntax. Key concepts are expanded to synsets, fields are identified, and contextual vocabulary is used but not passed through to the reformulated query. Examples of reformulated queries are:

[essay story writing] & ([sailing navigation]|[sailing gliding soaring]))

[medicine medication drug ]& [headache migraine]

[nonfiction “nonfictional prose” article]& (<author “Isaac Asimov” >)

[laptop “portable computer”] & (<screen large>) & (<weight under 7 lb>)

There may be several synsets for each key concept. For example, for the term sail, there might be three meanings (cruise, navigate, canvas) without the contextual words to choose between them. TurboSearch will then include all potentially relevant synsets in the reformulated query. So a question “sail” would result in a reformulated query like:

([sail canvas “canvas sheet” ] |[sail navigate] I [sail cruise])

Applications typically pass the query directly to TurboSearch, although some preprocessing may be provided if desired. Examples of application preprocessing are spell checking, wildcard expansion, user context expansion, and domain tagging. Some preprocessing may result in sets within the input, while some may result in XML tags being included with the question. An example of a set input is:

User question: “essays on sail*”

Application wild-card expansion: “essays on [sail sailor sailing sailboat]”

B. Query API—Syntax

TurboSearch can produce nearly any Boolean syntax as required by specific search engines. Reformulation can also be done directly to SQL if desired. An example of this syntax is shown below:

[] to contain a synset or other term expansion. All words and phrases contained within these brackets should be considered OR'd for a search

( ) to delimit components and shape precedence

{} to delimit fields

| for Boolean OR (disjunction)—items matching on either part are an overall match

& for Boolean AND (conjunction)—items must match both parts to be an overall match

˜ for negation—ANDNOT (applies to the whole set contained in parenthesis)

<field values> to show field identification within the string

“” to indicate phrases containing multiple words

space implied AND

This syntax supports reformulation of any input query. For an example question of “cheap hotels”, term expansion on each of these words would bring back the following in addition to the original question: “inexpensive hotels”, “inexpensive inns”, “inexpensive hostels”, “cheap inns”, and “cheap hostels”. Collapsing these into a Boolean expression would give us: “(cheap OR inexpensive) AND (hotel OR inn OR hostel)”. In the syntax described above, this would be:

([cheap inexpensive] & [hotel inn hostel])

C. Query API—XML-RPC Format

This TurboSearch design is stateless, so each query-response pair stands on its own. Moreover, the Query API consists of exchanges of XML documents: a query is an XML document that is well-formed and validated against query.dtd; and a response is an XML document that is well-formed and validated against response.dtd. The query need not be known for the application to understand and process the response, and the previous response needn't be known for TurboSearch to understand and process the next question.

The Query API is based on XML-RPC, so each query is an RPC call which contains an XML document which contains the question. The XML-RPC protocol is a simple means of remote procedure calling that works over the Internet, or any Intranet or Extranet.

An XML-RPC message is an HTTP-POST request. The body of the request is an XML document. A procedure executes on TurboSearch and it returns a formatted XML document as a response. Each request has a transaction id generated by the application. In addition, for some applications additional XML tags may be used (for example, to identify user context or domain).

The simple example below shows an XML document used to structure a question, within an XML-RPC call:

| | |
|---|---|
| *** | POST /RPC2 HTTP/1.0 |
| *** | Mozilla/4.0 (compatible; MSIE 5.01; Windows NT) |
| *** | Host: xmlrpc.lexeme.com |
| *** | Content-Type: text/xml |
| *** | Content-length: 340 |
| *** | |
| *** | <?xml version=“1.0” standalone=“yes”?> |
| *** | <!DOCTYPE RESPONSE SYSTEM “LingoMotorsQuery.dtd”> |
| *** | <methodCall> |

| | |
|---|---|
| *** | <methodName>LingoMotorsEngine.forTransactionId:processQuery:</methodName> |

| | |
|---|---|
| *** | <params> |

| | |
|---|---|
| *** | <param><value><int>12345</int></value></param> |
| *** | <param>How do I prepare bouillabaise?</param> |

| | |
|---|---|
| *** | </params> |

| | |
|---|---|
| *** | </methodCall> |

The response for this would be the following example:

| | |
|---|---|
| *** | HTTP/1.1200 OK |
| *** | Connection: close |
| *** | Content-type: text/xml |
| *** | Content-length: 270 |
| *** | Date: Fri, 28 Jul 2000 19:55:07 GMT |
| *** | Server: xmlrpc.lexeme.com Microsoft-IIS/5.0 |
| *** | |
| *** | <?xml version=“1.0” standalone=“yes”?> |
| *** | <!DOCTYPE RESPONSE SYSTEM “QrelResponse.dtd”> |
| *** | <methodResponse> |

| | |
|---|---|
| *** | <params> |

| | |
|---|---|
| *** | <param><value><int>12345</int></value></param> |
| *** | <param>([prepare cook fix] & [bouillabaisse “fish stew” ])</param> |

| | |
|---|---|
| *** | </params> |

| | |
|---|---|
| *** | </methodResponse> |

5. Field Identification

The Search Engine may accommodate a large variety of fields as inputs. Some of these fields may be linguistically derived by TurboSearch; others may be reserved for future use from either a GUI or from TurboSearch.

The following table summarizes the fields derived by TurboSearch in the current version:

| Search | | |
|---|---|---|
| Type | Query Element Format | Notes |
| Contri- | {contributor foo} | A Contributor may be used as |
| butor | | either an author or publisher |
| Price | {price ########} | All prices are represented as |
| | | ranges |
| Format | {format paperback} | paperback, hardcover. . .are |
| | | translated into |
| | {format hardcover} | internal codes inside the engine: |
| | {format audio} | paperback = TP \| MM |
| | {format ebooks} | hardcover = HC |
| | {format calendars} | ebooks = EA \| EB \| ED \| GB |
| | {format largeprint} | calendars = C \| CA \| DK \| PG \| WL |
| New | {new Y} | |
| Audi- | {aud_code juvenile} | |
| ence | {aud_code youngadult} | |

A. Contributor

This feature identifies contributors—people and organizations who are authors or editors—and maps them to the customer's Contributor Field. Turbo Search 1.1 improves what the system returns for queries which are ambiguous between identifying a contributor and specifying other search terms. Examples of phrases which should be recognized as contributors include: books from Oxford University Press→{contributor “oxford university press”}, the works of Jane Austen→{contributor “jane austen”}, books by Jane Austen→ {contributor “jane austen”}and Stephen King's thrillers→{contributor “Stephen king”} & [thrillers thriller].

B. Format

The system may allow users to search for books of specific format, e.g., ‘hardcover’ or ‘paperback’. This version of Turbo Search will map English language format expressions to the format field. The goal is to recognize and flag unambiguous expressions of format that are clearly defined in TurboSearch. This version will recognize these expressions and return the format field only, as opposed to returning the format field in disjunction with format term expansion. The treatment of expressions of format which are not explicitly defined as ambiguous will include either term-expansion or term-expansion disjoined with format field identification.

C. Price

This field maps English language price expressions to the price field. In this version, only expressions involving explicit numerical values are included. It will, however also recognize modifier adverbs such as under in under five dollars, monetary nouns, such as dollar and verbs expressing price information, such as cost.

Examples:

‘I want a book under 5 dollars’ {price 0ˆ 4.99}

‘I want a book over 5 dollars’ (unlikely query) {price 5ˆ inf}

‘I want books around 5 dollars’/‘I want a 5 dollar book’—give back arithmetic value {price 5}

‘I want a book between 5 and 10 dollars’{price 5ˆ 10}

D. Pub Date

This field will allow users to search for new or recently published books, defined as having a publishing date within the past six months. The goal is to recognize and flag user queries that refer to new books and recent editions. The qualifying terms for a specified pubdate field identification of RECENT are ‘new’, ‘newest’, ‘latest’, and ‘recent’.

E. Audience

This field will identify only “juvenile” and “youngadult”. Desired result: {audience juvenile} or {audience youngadult}. This field will be used to search for books with these codes in their database.

6. Stop Phrases

In the current version the list of stop phrases is substantially expanded to further improve on natural language processing. Since the stop phrases are ignored by the system, this expansion allows for many more phrasings by the user, thus making the system even more versatile. However, there will always be many ways to phrase a request and in order to better and more efficiently process this information, this version of TurboSearch introduces pattern matching to the stop phrase feature. Rather than having to exactly match the phrase the user types in, this version can recognize a variety of similar phrasings, making the system more robust as well as more quickly scaleable.

7. Linguistic Features

Features in the current version include:

A. Simultaneous adjective and relative clause interpretation; implementing this facility also allows for modifiction by multiple event adjectives and multiple (aka “stacked”) relative clauses

B. Distinctions between different types of possessive semantics

C. Full functionality of relative clauses (subject, object, adjunct relatives, and reduced relatives, with/without complementizers)

D. Generalized “Display This” functionality through Information Builders (general rules replacing long and inevitably incomplete lists of ignorable “stop phrases” that often begin user queries

E. Full qualia and argument binding capability for event nominals; in particular, binding of theme arguments of a head by a preceding nominal modifier (as in “sword swallowing”)

8. Vocabulary Building

We distinguish the following three categories of vocabulary:

A. Content vocabulary: these are the words and phrases that are semantically meaningful on their own, and have entries in our lexicon. (Ex: ‘children’, ‘France’, ‘restaurants’).

B. Function vocabulary: These words have no well-defined meaning on their own, but they have well-defined database semantics for selecting specific fields. (Ex: ‘in’, ‘by’, ‘during’, ‘books about’, ‘books by’)

C. Stop vocabulary: These words and phrases are ignored by the system. (Ex: ‘tell me about’, pronouns such as ‘you’, ‘me’, most prepositions, and other requesting or interrogative (questioning) phrases, such as “Do you have”, “where can I find”, and so on.)

TurboSearch uses these distinctions and the meaning of sentences to expand content vocabulary, discard stop vocabulary, and use function vocabulary in field identification or term expansion.

The vocabulary is built semi-automatically from product catalogs.

9. Performance and Operational Specs

TurboSearch is expected to have the following performance characteristics:

A. Latency (question to query time):

Average latency 200 milliseconds

<1% of queries to exceed 500 milliseconds

B. Throughput (queries per second at peak):

Total system throughput—100 queries per second

C. System Availability:

No downtime (24×7 operation)

2 or more disparate data centers (one being lights-out, one DC should be able to handle load)

D. Startup, reload time and updates:

Easy frequent reload of new versions with minimal impact to site performance

Ability to perform quick update of software (under 1 hour)

Ability to upgrade OS with minimal impact to site performance

Quick startup time (under 10 minutes)

10. Production Architecture

The diagram is FIG. 8E shows schematically the production (process) architecture of TurboSearch version 1.1. Each machine is a multi-processor computer running Windows 2000. Multiple copies of the TurboSearch process are used on a single machine, sharing a multi-threaded copy of LingoNet. LingoNet is instantiated as an Oracle database, and Oracle native facilities are used for updates, caching and thread management. A load balancer process allows the machine to appear as a single port to the search engine, and also allows for process control within the machine.

11. Installation and Packaging

The components available for installation on the TurboSearch Installation CD are:

A. Full Product Install (Recommended).

B. TurboSearch Services. Use this option to install only the TurboSearch engine and use a currently installed version of the LingoNet database.

C. LingoNet Database. Use this option to install only the LingoNet database and use an existing version of the TurboSearch engine.

12. System Management

The current TurboSearch version is hosted in Windows 2000, and uses the windows event log to report exceptions and error conditions. The following system management constructs are included in this version.

A. System Management primitives

a. startup

b. shutdown/restart

c. load new code image

d. load new database image (database machines only)

B. Logging -using Windows event log

a. Exceptions, alarms, startup/shutdown messages

C. Logging—using local file logs

a. Questions

b. Queries (reformulations)

c. Detailed traces/diagnostic output as appropriate

D. Engine statistics reporting

a. Query number, average throughput, max throughput, latency

b. Exceptions - count, type breakdown

c. Answer statistics - count, averages, type breakdown

d. Current size (lexical entries, types, memory)

e. Performance (average speed breakdown, machine utilization)

E. Database statistics reporting

a. Include base statistics akin to engine reporting

b. Current size (synsets, constituents)

c. Performance (average speed breakdown, machine utilization)

13. User Profiles

The following types of users are expected:

A. Users

The users of the system are online customers interested in locating and buying a book.

These customers are:

Searching for a particular book

Looking for particular information

Browsing for general information

B. Anticipated Purchasing Behavior

We anticipate purchase behavior to be one of three modes:

a. Predetermined—This consumer has an idea of the title, the author, or the subject of the book(s) she wants to buy. She may be in a hurry; she may be buying a gift.

b. Browse-based—This consumer has more time and may be enticed into browsing many topics that may be unrelated and buying books that were not on his original list.

c. Impulse—This consumer has a buying profile and responds to suggestions such as best sellers of a certain category, other titles on a similar subject, and new books by a favored author.

14. Metrics

The goals of metrics are:

Steer ongoing development and maintenance

Show improvement over conventional systems

Connect that improvement to business value

During version 1.1 development, only two search & navigation metrics will be in place: % Correct Reformulation, and First Page Relevance. However, a variety of additional measurements could be used in the deployment of TurboSearch, either simultaneous with TurboSearch deployment or at a later time. These include:

Business metrics

Customer Experience metrics

Search & Navigation metrics

Systems and operations metrics

Internal systems metrics

A. Businness Metrics

The ultimate goal of implementing new technology is higher business value, measured in dollars. (None of these metrics are part of the system per se, but they are described here because their implementation may occur concurrently with a deployment.)

Typical business metrics include: Conversion rate, Abandonment rate, Transaction rate, and Sales per transaction.

Common supporting measurements are: Number of Visits, Number of new customers, Number of repeat visits, Subjective customer loyalty, Brand awareness.

B. Customer Exerience Metrics

Overall, the goal is to provide a “knock-your-socks-off” customer impression, with high customer satisfaction. Typically, this is measured through site ratings, customer experience surveys and/or usability studies.

These may include the following measurements. Subjective ease of use, Overall Customer experience, Impulse purchases, Time spent shopping, Time to first relevant result, Average time to first selection.

C. Search & Navigation Metrics

The high-level goals for search and navigation quality are:

A. “Home run” results—numerous examples of “wow” answers to example questions

B. Better results than competitive sites on a selected set of “typical” queries

C. Good consistency—does not return “bizarre” answers

Two search & navigation metrics will be in place during the current version development:

A. % Correct Reformulation—this is a score of TurboSearch's output across a reference set of user queries. It will be manually scored at periodic points during development.

B. First Page Relevance—this is a score across a deployed system including the search engine and front end. The percentage of relevant answers for a reference set of queries will be manually scored across the development system and competitive sites.

Although the design and functional description is described in terms of specific hardware features, it would be recognized that there can be many alternatives, variations, and modifications. For example, any of the elements described above can be separated or combined. Alternatively, some of the elements can be implemented in software or a combination of hardware and software. Alternatively, the above elements can be further integrated in hardware or software or hardware and software or the like. It is also understood that the examples and embodiments described herein are for illustrative purposes only and that various modifications or changes in light thereof will be suggested to persons skilled in the art and are to be included within the spirit and purview of this application and scope of the appended claims.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for converting a keyword based search engine coupled to an information source into a natural language enhanced search engine, the method comprising:
determining expression based syntax of the keyword based search engine; and
coupling a natural language based search engine to the keyword based search engine based upon the expression based syntax by linking the natural language based search engine to the keyword based search engine.

2. A method of claim 1 wherein the expression based syntax is selected from a Boolean logic based rule, a not to exceed rule, and a within a number of characters rule.

3. A method of claim 1 further comprising determining a corpus of a database coupled to the keyword based search engine.

4. A method of claim 1 further comprising determining one or more database fields in the database and coupling the one or more database fields into the natural language based search engine to target a natural language query to the one or more of the database fields.

5. A method of claim 1 wherein the natural language based search engine uses semantic and syntax information of one or more of the terms of the natural language query.

6. A method of claim 1 further comprising training the natural language based search engine with a corpus of the information source.

7. The method of claim 1 further comprising identifying selected non-interesting terms.

8. The method of claim 1 wherein the natural language based search engine comprises a query reformulation module.

9. The method of claim 8 wherein the query reformulation module comprises a normalization module to provide the expression based syntax.

10. The method of claim 1 further comprising expanding a size of a text box for a graphical user interface coupled to the natural language based search engine.

11. A method for converting an information retrieval search engine coupled to an information source into a natural language enhanced search engine, the method comprising:
determining an expression based syntax of the information retrieval search engine, the information retrieval system comprising a graphical user interface coupled to a client device; and
coupling a query reformulation module to the information retrieval search engine, the query reformulation module being adapted to couple a natural language engine to the information retrieval search engine.

12. A system for forming query reformulation, the system comprising:
a receiving module for receiving a query in a form of a natural language expression in a logical form;
a query reformulation engine coupled to the receiving module, the query reformulation engine being adapted to receive the natural language expression in the logical form and to form a reformulated query from the natural language expression; and
a keyword based search engine coupled to the query reformulation reformulation engine to receive the reformulated query.
